(19) United States
(12) Patent Application Publication
(10) Pub. No.: US 2017/0021392 A1
(43) Pub. Date: Jan. 26, 2017

(54) DEVICE FOR CLEANING AND FINE-SORTING GRAIN METALLURGICAL WASTE FINES AND METHOD FOR CLEANING AND FINE-SORTING GRAIN METALLURGICAL WASTE FINES

(71) Applicant: PRZEDSIEBIORSTWO OBROTU SUROWCAMI WTÓRNYMI HERMEX", Herby (PL)

(72) Inventor: ADAM CZECH, HERBY (PL)

(73) Assignee: Przedsiebiorstwo Obrotu Surowcami Wtórnymi HERMEX" Adam Czech, Herby (PL)

(21) Appl. No.: 15/038,943

(22) PCT Filed: Nov. 25, 2014
(86) PCT No.: PCT/PL2014/000136

§ 371 Date: May 24, 2016

(30) Foreign Application Priority Data
Nov. 26, 2013 (PL) P-406250

(51) Int. Cl. B07B 9/02; B04C 5/04; B07B 7/04; B03C 1/30; B07B 4/04; B07B 7/02

(52) U.S. Cl. CPC B07B 9/02; B07B 4/04; B07B 7/02; B07B 7/04; B03C 1/30; B04C 5/04

(57) ABSTRACT

A device for cleaning and fine sorting grain metallurgical waste fines and the method for cleaning and fine-sorting grain metallurgical waste fines. The material is fed to the device for cleaning of fine metallurgical waste from the feeding tank (1), by means of a feeding mechanism (2) and is transported to initial separator (3), into which air is blown with a fan (4). The most dusty fractions hovering in the initial separator (3) are directed to the collector (6). However, the largest fractions of metallurgical waste fall to the bottom part, and they are removed with a cascade pipeline (7) directed upwards to the cascade separator (8). Lighter fractions accumulated in the cascade separator (8), are directed to the collector (6), and then to the next cascade separator (15), from where lighter and finer fractions of metallurgical waste are directed to expanded cascade separator (16), and the lightest fraction of waste are then directed to the cyclone dust collector (18).

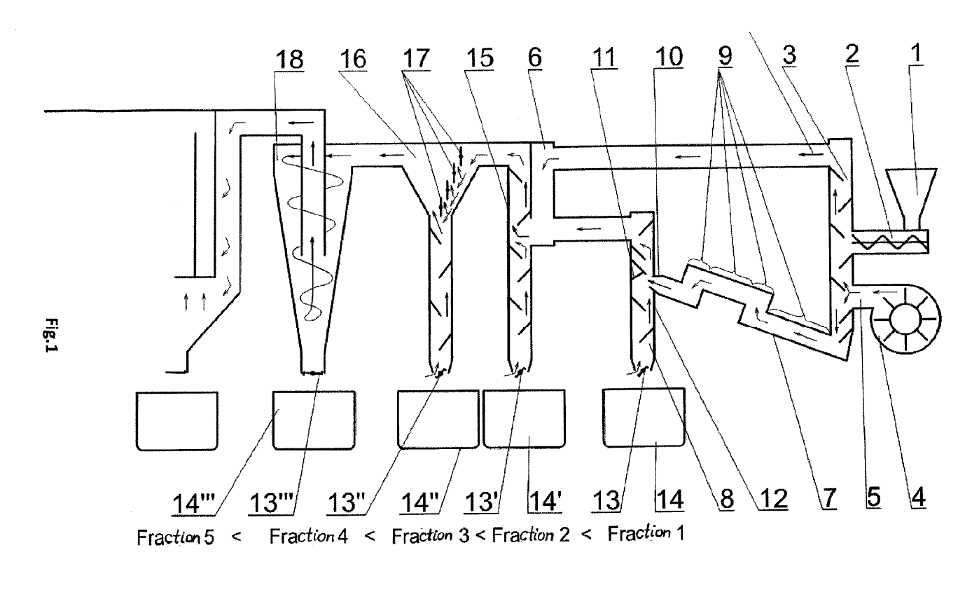

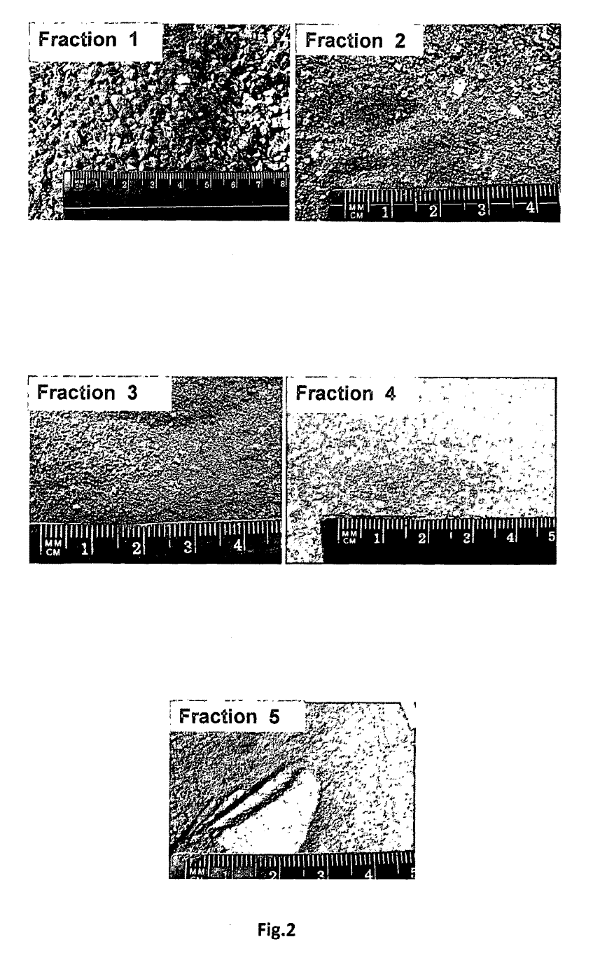

The subject of this invention is an apparatus for cleaning and grain sorting fine metallurgical waste material. The apparatus is intended for separation and cleaning loose substances, fine or reduced in size, which are contained in dusts and powders. The finest metallurgical waste material, in the form of dusts and powders, for example those produced after processing of melting loss in ball mills, contains fine grains of valuable metal, the recovery of which is technologically difficult.

The subject of this invention is also the method for cleaning and grain sorting fine metallurgical waste material.

The differences in physical properties of loose materials are used for separation and cleaning in the process of flow classification. The size of grains, their mass and density as well as hardness, grindability and impact strength are of great importance. In the flow apparatus the influence of air stream causes diverse behaviour of materials with different mass and grain sizes. When the air stream has low velocity, material with big mass reduces its speed which causes its precipitation and sedimentation of its particles, while material with less mass still remains in the stream of flowing air. With higher flow velocity and due to the change of stream direction the particles of material collide each other and affect the constructional elements of the apparatus, resulting in material breaking and cleaning.

Thus far various apparatus for separation of grains are known, including in particular various sieve shakers and cascade flow classifiers, described in subject literature [“Skrypt uczelniany. Maszynoznawstwo odlewnicze/University Textbook. Theory of Casting Machines. A. Fedoryszyn, K. Smykasy, E. Zió/lkowski. Uczelniane Wydawnictwo Naukowo-Dydaktyczne, Kraków 2008, p. 36 and 37]. The assembly of known cascade classifier consists of the set of segments, arranged in the cascade, with partitions located inside the segments.

The grains of fed materials are being separated as a result of the flow of air, supplied by a connector pipe. Fed material is supplied to the classifier from a tank, by means of a feeding screw. The products of separation are collected in a cyclone, placed in the upper part of the classifier (fine-grained product) and in a container placed under the outlet, in the lower part of the separator (coarse-grained product). The air from the cyclone is discharged, through a duct, to the fabric filter and extraction fan.

The “Apparatus for selective separation of coarse-grained fractions from polyfractional material with wide range of grain-size distribution” is known from the Polish description of patent application no. P-312403 (publication in BUP No. 15/1997). This invention resolves the issue if selective separation of coarse-grained fractions from polyfractional material with wide range of grain-size distribution. The apparatus consists of a flow duct built of external segments, in the form of truncated cones joined with bases. The pouring inserts are fixed inside of the segments. Polyfractional material flows gravitationally in the counter-current to the separating gas. An additional duct for separating gas supply, along with a valve, is placed in the upper part of the apparatus.

Another solution is known from the American patent description no. US2008023374, titled “Method and apparatus for separating residues”. It presents the apparatus for separating the residues from heat treatment into various fractions. This apparatus consists of a casing seated on self-aligning elements and fitted with several plates mounted inside and placed obliquely, one above another. The apparatus is fitted with vibrating elements, causing that separated material falls down from individual plates.

Another solution is presented in Japanese patent description no. JP53124192, titled “Method and apparatus for classifying and recovering granulated slag”. In this apparatus the individual fractions are separated by means of gases.

The Polish description of patent application no. P-395273, titled “Apparatus for cleaning and separating fine metallurgical waste material and method for cleaning and grain classification of fine metallurgical waste material” presents the apparatus equipped with vertically arranged cascade separator, inside of which the overpressure is produced. The separated material is transported by air stream, through the pipe for pneumatic transport, ended with a nozzle narrowing downwards and a breaking bumper located opposite to the nozzle outlet, to the separator's cleaning and separating column. Cleaned coarse-grained material is carried away through the lower outlet to the magnetic separator, where it is separated into fractions and directed to the outlet of magnetic fraction or to the outlet of non-magnetic fraction.

The purpose of invention is to develop an apparatus for separating and cleaning loose materials, which would be more efficient than the solutions known so far and additionally allow the separation of material into several fractions with various grain sizes, weight and other physical and chemical properties. The purpose of invention is also the development of method for recovering such types of fractions.

Developed separator for cleaning and grain sorting of fine metallurgical waste material consists of the feeding tank connected, by the loose material feeder, with vertically oriented initial separator. The air is blown by fan into the initial separator. The lower part of initial separator is connected, by an ascending pipeline, with the cascade separator. A bumper with cascades located over and under it, is installed in the central part of the cascade separator. These cascades are arranged obliquely and in some intervals from each other. A regulation damper, through which the accumulating heavier fractions of cleaned material are discharged to the magnetic separator and then to the external tank, or directly to the external tank, is located in the lower part of the cascade separator. The upper part of described cascade separator is connected with a filter, into which the lighter, floating fractions of cleaned fine metallurgical material, are introduced. The end part of the apparatus is the outlet, which can be connected with a fan or suction pump. The essence of developed solution is that the ascending pipeline is a cascade pipeline, and individual sections of this cascade pipeline have different diameter or they are arranged out-of-alignment or equipped with cascades, or they are spirally shaped.

Preferably, both the upper part of the initial separator and the upper part of the cascade separator are connected, by ducts, with the collector. The lightest, dusty fractions, separated in the initial separator and cascade separator are introduced to the collector, from where they are directed to the next cascade separator, connected with the collector. There is a regulation damper in the lower part of the next cascade separator and the air is sucked through this damper which causes that the finest fractions of material are raised upwards. The next, thicker fraction of separated metallurgical waste material is introduced through this damper and it is dumped, preferably to the magnetic separator and then to the external tank or directly to the external tank.

Preferably, the next cascade separator is connected with the expanded cascade separator, in the upper part of which there is a zone of adjustable vertical cascades. These vertical cascades form a kind of shutter and the inclination angle of this shutter can be appropriately adjusted. The stream of cleaned, fine metallurgical waste material, which is introduced to the expanded cascade separator from the next cascade separator, lands on this shutter.

Preferably, the cyclone dust collector is connected with the expanded cascade separator. From the expanded cascade separator the stream of fine waste material is introduced into the cyclone dust collector. There is a regulation damper in the lower part of the cyclone dust collector. Through this damper additional air can be sucked from outside and heavier fractions of waste material are discharged to the magnetic separator and external tank, or directly to the external tank.

Preferably, the separator for cleaning fine metallurgical waste material is equipped with at least one additional separator, preferably the cascade separator or additional cyclone dust collector.

The developed method for cleaning and grain sorting of fine metallurgical waste material consists in that the loose waste material is transported, by means of a feeder, from the feeding tank to a vertically oriented initial separator, preferably of cascade type, operating on the principles known so far, and simultaneously the air is blown into the initial separator by fan, preferably through a regulation damper. Then the overpressure is produced inside of the initial separator, giving the velocity to the particles of material, and then the loose material is “blown through”, which causes that the thickest fractions fall onto the bottom of initial separator, from where they are directed into the cascade separator, directly onto the bumper and the cascades located over and below it, where the grains are separated. The heaviest grains, that fall downwards, are discharged through the regulation damper, preferably to the magnetic separator, or directly to the external tank, while the fine grains floating in the air are carried away through the outlet. What is characteristic for this method, the initially separated material collected on the bottom of initial separator is moved with the air stream to the cascade separator, through a cascade pipeline, in which the cleaned and separated material gets broken and is crumbled against its walls.

Preferably, the most dusty fractions separated in the initial separator and also in the cascade separator, which raise up with the air, are directed to the collector, and then into the next separator, where this material is dispersed and additionally broken and its lightest, unwanted fractions are sucked up the separator. The heaviest, cleaned and coarse-grained fractions, that slide down, are discharged, preferably, to the magnetic separator and then to the external tank, or directly to the external tank.

Preferably, the most dusty fractions separated in the next separator, that raise up with the air, are directed to the expanded cascade separator, where the stream is directed to the zone of regulated cascades, which form a shutter. The inclination angle of this shutter can be appropriately adjusted. Then the heavier, separated fractions of material, which moved downwards, are discharged similarly through the regulation damper, preferably to the magnetic separator or directly to the external tank.

Preferably, the floating lightest fractions of waste material are directed from the expanded cascade separator to the cyclone dust collector, from where they are, through the regulation damper, introduced, preferably to the magnetic separator, or directly to the external tank, as the next fraction of separated metallurgical waste material, and during the operation of the cyclone dust collector the regulation damper remains, preferably closed.

Very fine waste material, including the fractions of fine aluminium melting loss, containing metallic aluminium, metal oxides and metal salts, can be processed in the developed separator for cleaning fine metallurgical waste material. As the fine, segregated metallurgical waste materials are moved in the developed apparatus, the materials with different grain size, mass and physical and chemical properties are separated very efficiently. The segregation of waste material and division into individual fractions also take place here. For example, as it results from conducted experiments, in the developed apparatus, in which the method described for the invention is applied, about 150-400 kg of material (from 15 to 40%) is obtained from one ton of broken up aluminium melting loss, and after magnetic separation this material can be used for melting of aluminium alloys or aluminium defined as so-called “secondary” aluminium. Obtained material can be also used as deoxidizer in metallurgical processes. Some of material fractions obtained in described process, which contain less than 40% of metal, can be also used as deoxidizers and insulating or exothermic casting powders in steel metallurgy process and in casting of metals. Obtained material, containing less than 10% of metallic aluminium, can be used for production of synthetic slags for steel refining and as an additive for slag fluxing in steel-making processes.

The subject of invention is demonstrated in the embodiment, in the drawing presenting the scheme of separator for cleaning fine metallurgical waste material.

As shown in the drawing, a loose material, usually with diameter below 5 mm, is fed, through the feeding tank 1, to the developed separator for cleaning fine metallurgical waste material. By means of the loose material feeder 2 (e.g. screw or bucket feeder, etc.) this loose material is moved to the vertically oriented initial separator 3, preferably of cascade type, which operates on the principles known so far. The air is blown into the initial separator 3 by the fan 4, preferably through the regulation damper 5, producing overpressure inside of initial separator 3 and giving velocity to the particles of initially cleaned and separated material. The most dusty fractions, which raise up along with the air in the initial separator 3 are discharged to the collector 6, while the thickest fractions of metallurgical waste material, due to gravity and their own weight, fall down to its lower part, from where they are carried away, by an ascending cascade pipeline 7, to the cascade separator 8. However individual sections 9 of the cascade pipeline 7 are of various diameters or are not arranged coaxially or are equipped with cascades or may be spirally shaped, so that during transportation of preselected material, its flow is disturbed and the fractions—usually the heaviest ones—change the direction of movement, which additionally facilitates breaking and cleaning of the grain surface. The operation [principle of the cascade pipeline 7 consists in change of movement trajectory of the particles transported pneumatically in a two-phase stream, ending preferably with nozzle 10, which increases flow rate of the preselected material, which may undergo further technological operations. The waste transported upstream the cascade pipeline 7 are directed to bumper 11 in the cascade separator 8 and then come across cascades 12 located above and under the bumper, consequently the material is additionally refined and dispersed and the efficiency of grain separation and cleaning is increased. Whereby the cascades 12 are arranged askew, in certain distance from each other, they are inclined downwards, and vertically they overlap, so to say. The material to be cleaned is introduced to cascade separator 8 and is poured on the cascades 12 downwards, being blown through, and while the largest fractions fall down to the bottom of the cascade separator 8 due to gravity and their own weight, the lighter fractions move upwards. So to say “On their way up” the fractions come across cascades 12, that additionally obstruct the movement up of the heavier grain and thus support separation of larger fractions. The larger fractions that accumulate at the bottom of the cascade separator 8 are removed by means of regulation damper 13, through which the air is sucked in and the smallest fractions of material are lifted up. Through the regulation damper 13 the fine grained material is moved, preferably to a magnetic separator, or directly to the external tank 14. On the other hand, the lighter fractions moving upwards and collected in cascade separator 8 are directed to the collector 6 and then to the next cascade separator 15, where the cleaning process is analogical to cascade separator 8. From the cascade separator 8, analogically, through a regulation damper 13″ next fraction, of determined grain size and weight, is collected, preferably to a magnetic separator, or directly to the external tank 14″.

Whereas the lighter and finer fractions of the metallurgical waste, that are isolated as described above, are directed to expanded cascade separator 16, where the stream hits the area of adjustable, basically vertical cascades 17, creating a shutter, so to say, the angle of which may be additionally adjusted. The adjustable cascades 17 overlap and they are arranged basically vertically, and the material directed at them hits them and slides down from one cascade onto another, lower cascade, and finally the largest fractions find their way to the main column of the expanded cascade separator 16. Analogically, the largest fraction is removed through a regulation damper 13″ preferably to a magnetic separator, or directly to the external tank 14″, whereas the lightest, hovering fractions are directed to the cyclone dust collector 18.

The material directed to the cyclone dust collector 18 goes inside tangentially to the internal walls of the conical housing of the cyclone dust collector 18, which causes the whirl of material and subjects the material to centrifugal force. Consequently, lighter fractions concentrate on the walls and slide down, where they are removed analogically through a regulation damper 13″ directly to the external tank 14′ as a next fraction of material, whereas the regulation damper 13′″ during operation of cyclone dust collector is preferably closed. The lightest, dust fractions—isolated during the described process, carried out on cooperating and arranged in series separators, creating an assembly that may be developed to include greater quantity of separators (depending on the number of fractions and the physical and chemical properties of the material we want to obtain), at the end of such assembly there is a cyclone dust collector 18—and the lightest fractions are sucked from the middle part of the cyclone dust collector 18 and are introduced to the filter 19, preferably a jet filter. And at the outlet 20, through which clean air is let outside, possibly additional negative pressure is created by means of fans or suction pumps 21. The remaining dust is collected, as the most isolated and lightest fraction of the cleaned material, in the external tank 14″″.

### LIST OF ELEMENTS

1—feeding tank,
2—feeding mechanism,
3—initial cascade separator,
4—fan,
5—damper,
6—collector,
7—cascade pipeline,
8—cascade separator,
9—section (of a pipeline),
10—nozzle,
11—bumper,
12—cascade,
13—regulation valve/damper,
14—external tank,
15—next cascade separator,
16—expanded cascade separator,
17—adjustable cascade,
18—cyclone dust collector,
19—filter,
20—outlet (of air),
21—suction pump.

1. The device and fine sorting grain for cleaning of fine metallurgical waste tines,
composed of feeding tank connected to feeding mechanism for loose material, with vertically oriented initial separator, into which air is blown by means of a fan, and with bottom part connected by means of an ascending pipeline with a cascade separator. In the middle part of the cascade separator there is a bumper with cascades located above and under the bumper, the cascades are arranged askew and in certain distance from each other, whilst in the bottom part of the cascade separator there is a regulation damper, through which the larger fractions of the cleaned material are discharged to a magnetic separator and later to an external tank or directly to an external tank, whereby the upper part of the described cascade separator is connected to a filter, into which the lighter, hovering fractions of cleaned fine metallurgical material are introduced, and the end element of the apparatus is an outlet optionally connected with a fan or a suction pump, wherein the ascending pipeline is a cascade pipeline (7), whereby individual sections (9) of the cascade pipeline (7) are of different diameter or are not arranged coaxially or are equipped with cascades or are of spiral shape.

2. The device and fine sorting grain for cleaning of fine metallurgical waste fines, according to claim 1, wherein
both the upper part of the initial separator (3) and the upper part of the cascade separator (8) are connected by means of ducts to the collector (6), into which the lightest, dusty fractions, isolated in the initial separator (3) and in the cascade separator (8). Those lightest fractions are then directed to the next cascade separator (15), in its bottom part there is a regulation damper (13′), by means of which the air is sucked in and the finest fractions are lifted up; by means of this dumper next, coarser fraction of isolated metallurgical waste is introduced and is preferably poured to the magnetic separator and then to the external tank (14′), or possibly directly to the external tank (14′).

3. The device and fine sorting grain for cleaning of fine metallurgical waste fines, according to claim 2, wherein the next cascade separator (15) is connected with the expanded cascade separator (16), which has an area of adjustable vertical cascades (17), creating a shutter, so to say, the angle of the shutter may be adjusted. The stream of cleaned fine metallurgical waste introduced to the expanded cascade separator (16) from the next cascade separator (15) goes to the shutter.

4. The device and fine sorting grain for cleaning of fine metallurgical waste fines, according to claim 3, wherein the cascade separator (16) is connected with the cyclone dust collector (18), into which a stream of fine waste is introduced from the expanded cascade separator (16), in the bottom part of the cyclone dust collector there is a regulation valve (13′″), through which additional air can be sucked from outside and through which larger fractions are removed to the magnetic separator and to the external tank (14′″), or directly to the external tank (14′″).

5. The device and fine sorting grain for cleaning of fine metallurgical waste fines, according to claim 1, wherein is equipped with at least one additional separator, preferably a cascade separator (8) or with additional cyclone dust collector (18).

6. The method for cleaning and fine-sorting grain metallurgical waste fines that consists in feeding loose waste material from the feeding tank by means of a feeding mechanism to the vertically oriented initial separator, preferably a cascade separator, operating on to-date known principles and simultaneously to the inside of the initial separator air Is blown with a fan, preferably through the regulation damper, thus positive pressure or overpressure, is created inside the initial separator and the particles of the material speed up, and later the loose material is “blown” and as a result the largest fractions fall down to the bottom of the initial separator and are then directed to the inside of the cascade separator, directly to a bumper and cascades located under and over the bumper, where the largest grain is selected, while the grain that well down is removed by means of regulation damper, preferably to the magnetic separator, or directly to the external tank and finest particles, lifted up with the air are removed through an outlet, wherein the preselected material, accumulated on the bottom of the initial separator (3) is transported with the stream of air to the cascade separator (8) through the cascade pipeline (7), where the clean and prepared material breaks up and is reduced on its walls.

7. The method for cleaning and fine-sorting grain metallurgical waste fines in accordance with claim 6, wherein the most dusty fractions isolated in the initial separator (3), as well as in the cascade separator (8), lifted up with the air are directed to the collector (6), and then to the next separator (15), where the material is dispersed and additionally breaks up, and its lightest undesirable fractions are sucked up to the top of the separator, and the largest cleaned coarsegrained fractions sliding down are removed, preferably to the magnetic separator and to the external tank (14′), or directly to the external tank (14′).

8. The method for cleaning and fine-sorting grain metallurgical waste fines in accordance with claim 7, wherein the most dusty fractions isolated in the next separator (15), lifted up by the air, are directed to the expanded cascade separator (16) where the stream is directed to the area of adjustable cascades (17), that create a shutter. The angle of the shutter is adjusted appropriately and the largest, isolated fractions of the material, that were transported downwards are analogically removed through the regulation valve 13″, preferably to the magnetic separator or to the external tank 14″.

9. The method for cleaning and fine-sorting grain metallurgical waste fines in accordance with claim 8, wherein the hovering, lightest fractions of waste are directed from the expanded cascade separator (16) to the cyclone dust collector (18), from where they are removed by means of a regulation dumper (13′″), preferably to a magnetic separator or directly to the external tank (14′″), as another fraction of isolated metallurgical waste, and the regulation dumper (13′″) is preferably closed during operation of the cyclone dust collector (18).
